(19) United States
(12) Patent Application Publication
(10) Pub. No.: US 2012/0173701 A1
(43) Pub. Date: Jul. 5, 2012

(54) MATCHING TECHNIQUES FOR CROSS-PLATFORM MONITORING AND INFORMATION

(75) Inventor: Michael Tenbrock, Columbia, MD (US)

(73) Assignee: Arbitron Inc., Columbia, MD (US)

(21) Appl. No.: 12/981,931

(22) Filed: Dec. 30, 2010

(51) Int. Cl. G06F 15/173

(52) U.S. Cl. 709/224

(57) ABSTRACT

Systems and methods are disclosed for employing matching techniques for cross-platform monitoring. A content sequence is produced for determining network content accessed at certain times by a computer registered to a particular user. Another content sequence is produced for determining media exposure at certain times for a portable user device registered to the same user. The content sequences are then processed and compared in a resolution server to validate the content sequences against each other, and to populate either or both sequences with missing data.

### TECHNICAL FIELD

The present disclosure relates to methods, systems and apparatus for monitoring, gathering and processing information relating to media across different mediums and platforms.

### BACKGROUND INFORMATION

Content providers and advertisers have a considerable interest in determining the amounts and types of users/panelists that are exposed to particular content. In the case of Internet content, websites and advertisers have long relied on “cookies” and other related technology for monitoring and tracking web pages and content being accessed by users. In the case of broadcast media, companies like Arbitron have relied on embedded audio codes (e.g., Critical Band Encoding Technology (CBET)) as well as audio signature-matching and pattern-matching technology to monitor and track exposure of panelists to broadcast media (e.g., radio, television). In other types of media, such as billboard, signage, publication, and/or product exposure, various techniques have been implemented using proximity-based sensors to determine what users are being exposed to in commercial establishments.

One of the issues facing content providers and advertisers is that monitoring panelist content exposure across different platforms is relatively inefficient and, at times, unreliable. As more content becomes integrated across different platforms, it will become increasingly important to measure, determine, and verify content exposure among these platforms. Accordingly, there is a need to develop systems and methods for cross-platform monitoring and matching.

### SUMMARY

Systems, apparatuses and method are disclosed allowing content providers and advertisers to accurately measure exposure to A/V media content. One portion of the system measures data pertaining to a computer network, while another portion measures data relating to audio signals of the A/V media content. As the network and audio data is accumulated, each portion of the system creates respective content sequences, indicating a sequence in which media was played for a specific user. The respective sequences are then processed in a resolution processor to compare the sequences to verify the content sequence and confirm the presence of a user. Additional processing may be utilized to adjust the comparison process and increase/decrease the sensitivity of the system.

### BRIEF DESCRIPTION OF THE DRAWINGS

FIG. 1A is an exemplary block diagram of a portion of a content matching system under one embodiment;

FIG. 1B is an exemplary block diagram of another portion of the content matching system illustrated in FIG. 1A;

FIG. 1C is an exemplary block diagram of a portable user device used in the embodiment of FIG. 1B;

FIG. 2 is an exemplary sequence of content exposure from a server utilized, in the illustration of FIG. 1A;

FIG. 3 is an exemplary sequence of content exposure from another server utilized in the illustration of FIG. 1B;

FIG. 4A is an exemplary matching process for resolving content exposure between two platforms;

FIG. 4B is another exemplary matching process for resolving content exposure between two platforms;

FIG. 5A is an exemplary matching and resolution process for determining content exposure between two platforms; and

FIG. 5B is another exemplary matching and resolution process for determining content exposure between two platforms.

### DETAILED DESCRIPTION

Various embodiments of the present invention will be described herein below with reference to the accompanying drawings. In the following description, well-known functions or constructions are not described in detail since they would obscure the invention with unnecessary detail.

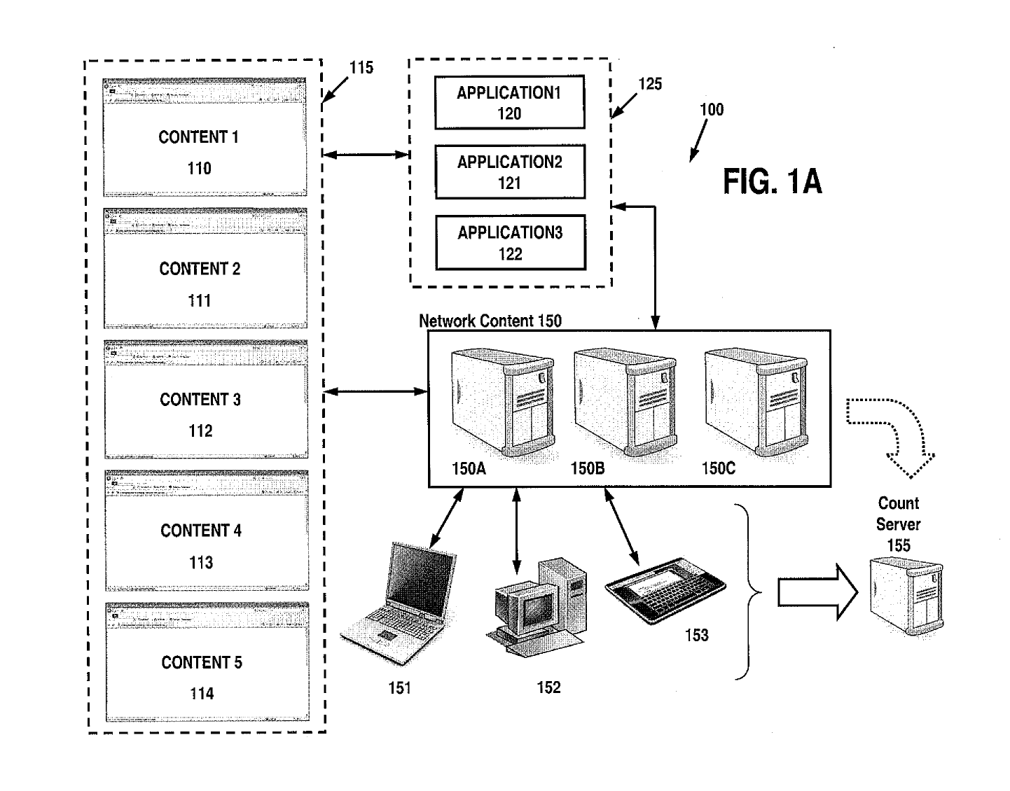

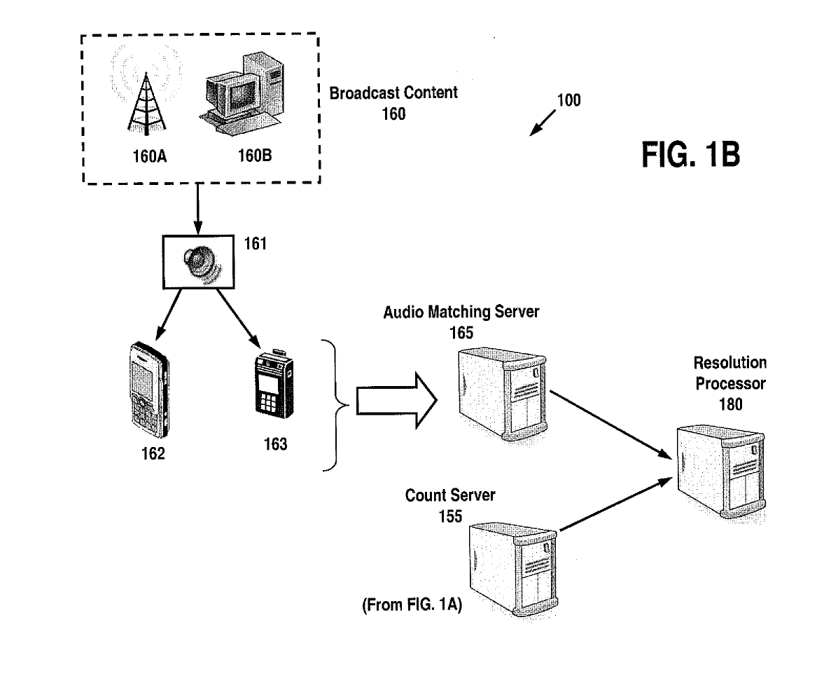

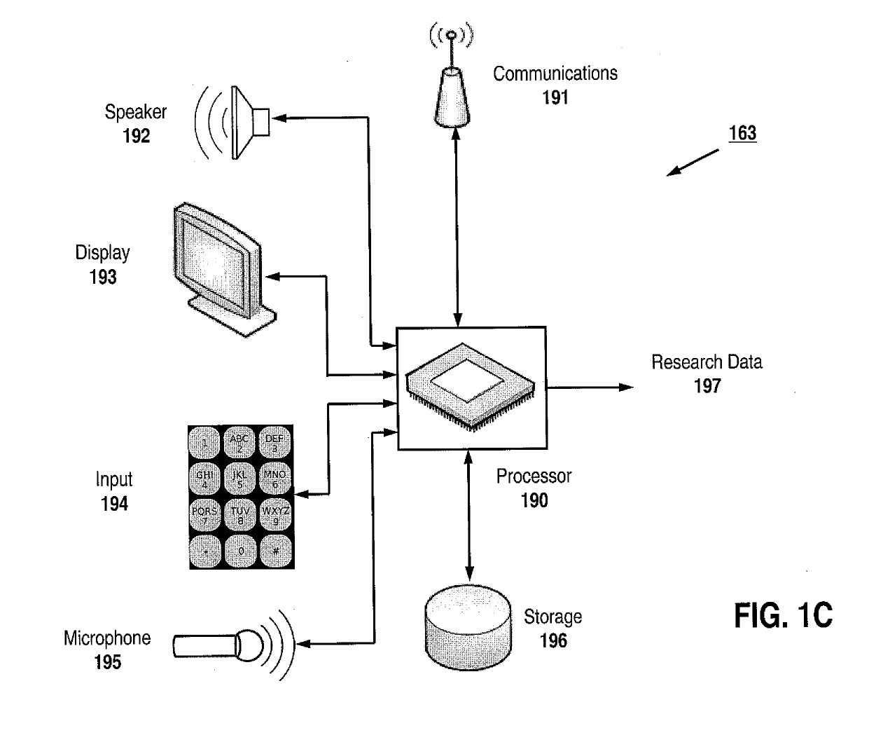

Turning to FIG. 1A, a content matching system 100 is disclosed, where users access content 115 over a computer network and/or telecommunication network. Typically, users will access the network using processor-based devices such as a laptop 151, a personal computer 152 or a portable computing device 153 (e.g., iPad™, iPhone™, Blackberry™, etc.). User access to the network may be achieved using any of a number of known wired or wireless connections known in the art. When connected, users may access network content 150 which may be one or more websites comprising of one or more content servers (150A-C).

The one or more servers (150A-C) providing network content 150 are arranged so that content 115 can be served to users directly, or through one or more of a plurality of software applications 125, such as Facebook™, Myspace™, YouTube™ or Hulu™. Software applications 125 may be accessed from network content 150, or can alternately reside locally on individual user devices (151-153).

In the exemplary embodiment of FIG. 1A, five different media contents (content 1-5, ref. 110-114) are accessible through three different software applications (application 1-3, ref. 120-122). The media content is preferably audio/video (A/V) content, but other types of content are applicable to the present disclosure as well. During normal operation, each user device (151-153) would run a software application such as a browser for accessing and displaying web pages containing media content 115. In response to a user command such as clicking on a link or typing in a URL, user device 151-153 issues a web page request that is transmitted via the Internet to one or more of the content servers 150A-C. In response to the request, the one or more content servers transmit HTML code to a respective user device. The browser then interprets received HTML code to display the requested web page on the respective device and/or run any embedded code containing A/V content.

When users access content 115 from their devices, it is preferable that their on-line activities (also referred to as “clickstream data”) be collected and analyzed at count server 155. This can be accomplished for smaller amounts of content using logfile analysis via web server logs and optional cookie information. For larger amounts of content, it is preferable to employ the use of embedded references to web beacons (also referred to as “Clear GIFs,” “Web Bugs,” or “Pixel Tags”). Web beacons are preferably in the form of a very small graphic image (e.g., 1 pixel by 1 pixel in size) which is typically clear or transparent. Depending on how the web beacon reference is encoded in the web page definition, and depending on the user's actions when viewing a web page, or viewing or listening to A/V content, a request message will be issued from the user's device to retrieve the file containing the web beacon. Because of its small size and transparency, the web beacon that is rendered on the user's display is relatively unobtrusive. Often, the web beacon uses executable code written in JavaScript (or other suitable language) to report on the content of the respective web page by sending a message with information about the particular page within which the web beacon was requested. The HTTP request header which requests delivery of the web beacon also supplies certain types of information about the client, such as the user agent (i.e. browser) in use at the time, what types of encoding the user agent supports, as well as other information. When using web beacon in this manner, the user's browser sends clickstream data directly to a site analysis application preferably stored on count server 155. Additionally, a web beacon may include software script that is carried with text or A/V content that already includes or actively gathers data about the content, the content's origin and travel path (e.g. referral page), the device, the network (e.g., IP address and network travel path, ISP) and content usage (e.g., duration, rewind), and reports this data to count server 155.

Whenever a web page, with our without beacons, is downloaded, the server holding the page knows and can store the IP address of the device requesting the page. This information can also be retrieved from the server log files. Preferably, web beacons are used when user monitoring is done by a server that is different from the one holding the web page(s). This can be advantageous for example when the web pages are served by different servers, or when monitoring is done by a third party. When web beacons are requested, they typically send the server their URL, as well as the URL of the page containing them. The URL of the page containing the beacon allows the server (count server 155) to determine which particular web page the user has accessed. The URL of the beacon can be appended with an arbitrary string in various ways while still identifying the same object. This extra information can be used to better identify the conditions under which the beacon was loaded, and can be added while sending the page or by JavaScripts after the download.

Turning to FIG. 1B another portion of content matching system 100 is illustrated, where broadcast content 160 is played through a speaker system 161, and acoustically received by one or more portable user devices 162, 163. The portable device may be in the form of a cell phone 162, equipped with dedicated software for producing research data from the audio signal. Alternately, the portable device may be a specially designed portable device, such as an Arbitron Personal People Meter™ (or “PPM”), that is capable of producing the aforementioned research data. Broadcast content 160 may be in any form, such as radio or television broadcast 160A, or alternately be Internet-based content 160B. In the embodiment of FIG. 1B, broadcast content 160 may be the identical content served to network content 150 discussed above in FIG. 1A. However, unlike the embodiment in FIG. 1 A, the portable devices 162, 163 gather research data from the acoustic signals emanating from speaker 161.

The acoustic signals in FIG. 1B may be encoded or non-encoded signals. Portable devices 162, 163 may also be capable of encoding and decoding broadcasts or recorded segments such as broadcasts transmitted over the air, via cable, satellite or otherwise, and video, music or other works distributed on previously recorded. An exemplary process for producing research data comprises transducing acoustic energy to audio data, receiving media data in non-acoustic form in a portable device and producing research data based on the audio data, and based on the media data and/or metadata of the media data.

When audio data is received by the portable device, which in certain embodiments comprises one or more processors, the portable device forms signature data characterizing the audio data. Suitable techniques for extracting signatures from audio data are disclosed in U.S. Pat. No. 6,996,237 to Jensen et al, U.S. Pat. No. 6,871,180 to Neuhauser et al., U.S. Pat. No. 5,612,729 to Ellis, et al. and in U.S. Pat. No. 4,739,398 to Thomas, et al., each of which is assigned to the assignee of the present invention and each of which are incorporated by reference in their entirety herein.

When using techniques utilizing “signature” extraction and/or pattern matching, a reference signature database is formed containing a reference signature for each program in the media data for which exposure is to be measured. The reference signatures are created by measuring or extracting certain features of the respective programs before broadcast. Upon reception of the media data, signature extraction is again performed, and the extracted signatures are compared to the reference signatures to find matches.

Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al, U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,531 to Kenyon, et al., U.S. Pat. No. 4,230,990 to Lert, et al., U.S. Pat. No. 5,594,934 to Lu, et al., and PCT publication WO91/11062 to Young, et al., all of which are incorporated by reference in their entirety herein.

FIG. 1C is an exemplary block diagram of portable user device 163 modified to produce research data 197. The portable user device 163 may be comprised of a processor 190 that is operative to exercise overall control and to process audio and other data for transmission or reception, and communications 191 coupled to the processor 190 and operative under the control of processor 190 to perform those functions required for establishing and maintaining a two-way wireless communication link with a portable user device network. In certain embodiments, processor 190 also is operative to execute applications ancillary or unrelated to the conduct of portable user device communications, such as applications serving to download audio and/or video data to be reproduced by portable user device 163, e-mail clients and applications enabling the user to play games using the portable user device 163. In certain embodiments, processor 190 comprises two or more processing devices, such as a first processing device (such as a digital signal processor) that processes audio, and a second processing device that exercises overall control over operation of the portable user device. In certain embodiments, processor 190 employs a single processing device. In certain embodiments, some or all of the functions of processor 104 are implemented by hardwired circuitry.

Portable user device 163 is further comprised of storage 196 coupled with processor 190 and operative to store data as needed. In certain embodiments, storage 196 comprises a single storage device, while in others it comprises multiple storage devices. In certain embodiments, a single device implements certain functions of both processor 190 and storage 196.

In addition, portable user device 163 includes a microphone 195 coupled with processor 190 to transduce audio to an electrical signal, which it supplies to processor 190, and speaker and/or earphone 192 coupled with processor 190 to transduce received audio from processor 190 to an acoustic output to be heard by the user. Portable user device 163 may also include user input 194 coupled with processor 190, such as a keypad, to enter telephone numbers and other control data, as well as display 193 coupled with processor 190 to provide data visually to the user under the control of processor 190.

In certain embodiments, portable user device may provide additional functions and/or comprises additional elements. In certain examples of such embodiments, portable user device provides e-mail, text messaging and/or web access through its wireless communications capabilities, providing access to media and other content. For example, Internet access by portable user device enables access to video and/or audio content that can be reproduced by the cellular telephone for the user, such as songs, video on demand, video clips and streaming media. In certain embodiments, storage 196 stores software providing audio and/or video downloading and reproducing functionality, such as iPod™ software, enabling the user to reproduce audio and/or video content downloaded from a source, such as a personal computer via communications 191 or through direct Internet access via communications 191.

To enable a portable user device to produce research data, research software is installed in storage 196 to control processor 190 to gather such data and communicate it via communications 191 to a centralized server system such as audio matching server 165. In certain embodiments, research software controls processor 190 to decode ancillary codes in the transduced audio from microphone 195 using one or more of the techniques identified hereinabove, and then to store and/or communicate the decoded data for use as research data indicating encoded audio to which the user was exposed. In certain embodiments, research software controls processor 190 to extract signatures from the transduced audio from microphone 195 using one or more of the techniques identified hereinabove, and then to store and/or communicate the extracted signature data for use as research data to be matched with reference signatures representing known audio to detect the audio to which the user was exposed. In certain embodiments, the research software both decodes ancillary codes in the transduced audio and extracts signatures therefrom for identifying the audio to which the user was exposed. In certain embodiments, the research software controls processor 190 to store samples of the transduced audio, either in compressed or uncompressed form for subsequent processing either to decode ancillary codes therein or to extract signatures therefrom. In certain examples of these embodiments, compressed or uncompressed audio is communicated to a remote processor for decoding and/or signature extraction.

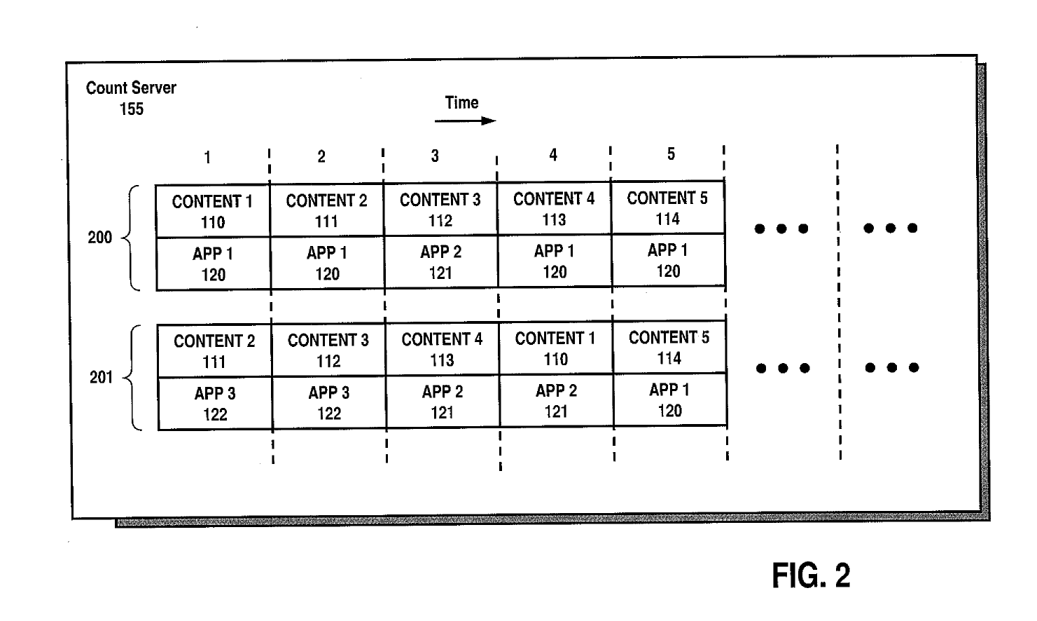

Referring back to FIG. 1B, research data 197 produced by portable devices 162, 163 is communicated to audio matching server 165, where the research data is processed to determine media exposure for each respective device. Similarly, clickstream data and other related data is processed in count server 155. Both the audio matching server 165 and count server 155 then communicate their respective data to resolution processor 180 for further processing. Further detail regarding these processes is discussed below in connection with FIGS. 2-5B.

FIG. 2 illustrates an exemplary content sequences generated in count server 155 using at least part of the clickstream data produced from user devices 151-153 of FIG. 1A. The content sequence may be configured to cover discreet time periods identified via time stamps identifying times when content was accessed. Alternately, the content sequence may be established using a plurality of predetermined time sequences. Preferably, content sequences are determined using discreet time periods identified via time stamps. This configuration is preferable in cases where content can viewed in real-time (e.g. streaming A/V) or downloaded and viewed at a later time. A device could gather data identifying where content was downloaded and the original source and match the gathered data with pre-stored information. When the content is viewed or listened to, the pre-stored information may be combined and matched with the audio information. An exemplary first sequence 200 for a user's device illustrated in FIG. 2 shows that:

Content1 (110) was accessed using Application1 (120) at Time1;
Content2 (111) was accessed using Application1 (120) at Time2;
Content3 (112) was accessed using Application2 (121) at Time3;
Content4 (113) was accessed using Application1 (120) at Time4; and
Content5 (114) was accessed using Application1 (120) at Time5.
A second sequence 201 for another user's device shows that:
Content1 (111) was accessed using Application3 (122) at Time1;
Content3 (112) was accessed using Application3 (122) at Time2;
Content4 (113) was accessed using Application2 (121) at Time3;
Content1 (110) was accessed using Application2 (121) at Time4; and
Content5 (114) was accessed using Application1 (120) at Time5.
Thus, the count server can establish for example that a user viewed a music video using Facebook™at 12:15PM, then viewed a movie preview using Facebook™at 12:20PM, then listened to a streaming audio program using Shoutcast™at 12:30PM. It is important to note that the clickstream data can contain additional information, such as originating source data, to obtain further information. In such a case, and following the preceding example, the count server can establish that a user viewed a music video from VH1 using Facebook™at 12:15PM, then viewed a movie preview from NBC using Facebook™ at 12:20PM, then listened to a streaming audio program from WABC using Shoutcast™ at 12:30PM.

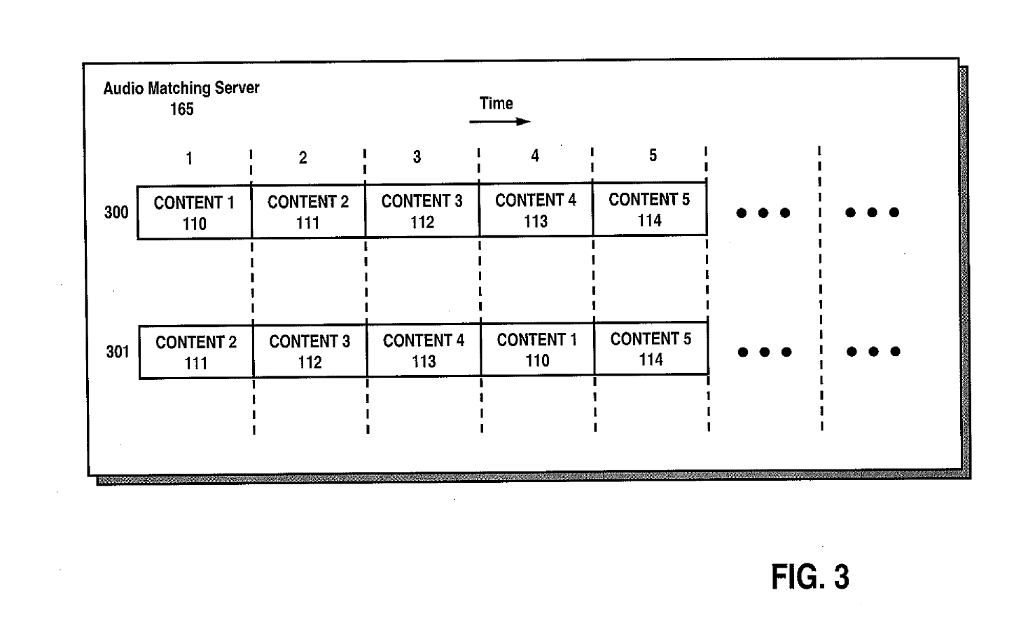

Turning to FIG. 3, a separate content sequence is produced in the audio matching server 165 using the research data produced from portable devices 162, 163 of FIG. 1 B. Just as in the count server 155, the content sequence in the audio matching server 165 may be configured to cover discreet time periods identified via time stamps identifying times when the portable device was exposed to the audio signal. Alternately, the content sequence may be established using a plurality of predetermined time sequences. The first audio matching sequence 300 shows that:

Content1 (110) was heard at Time1;
Content2 (111) was heard at Time2;
Content3 (112) was heard at Time3;
Content4 (113) was heard at Time4; and
Content5 (114) was heard at Time5.
The second audio matching sequence 301 for another user's device shows that:
Content2 (111) was heard at Time1;
Content3 (112) was heard at Time2;
Content4 (113) was heard at Time3;
Content1 (110) was heard at Time4; and
Content5 (114) was heard at Time5.
Thus, the audio matching server can establish for example that a user heard a music video at 12:15PM, then heard a movie preview at 12:20PM, then listened to a streaming audio program at 12:30PM.

In the embodiment of FIG. 3, additional audio codes may be used. For example, source codes may also be included in the audio signal to identify an originating source for the content (e.g., NBC). Thus, continuing with the above example, the audio matching server can establish that a user heard a music video from VH1 at 12:15PM, then heard a movie preview from NBC at 12:20PM, then listened to a streaming audio program from WABC at 12:30PM. In cases where only content information is included in the audio signal, the content codes can be matched with the content codes and source codes identified from the clickstream data to derive a source for the audio signal. This configuration can be particularly advantageous in that source codes for audio encoding would not be necessary at each source broadcasting A/V content over a network. Additionally, the codes from the clickstream data can be used to supplement audio codes, particularly in cases where audio source codes are missing or corrupted.

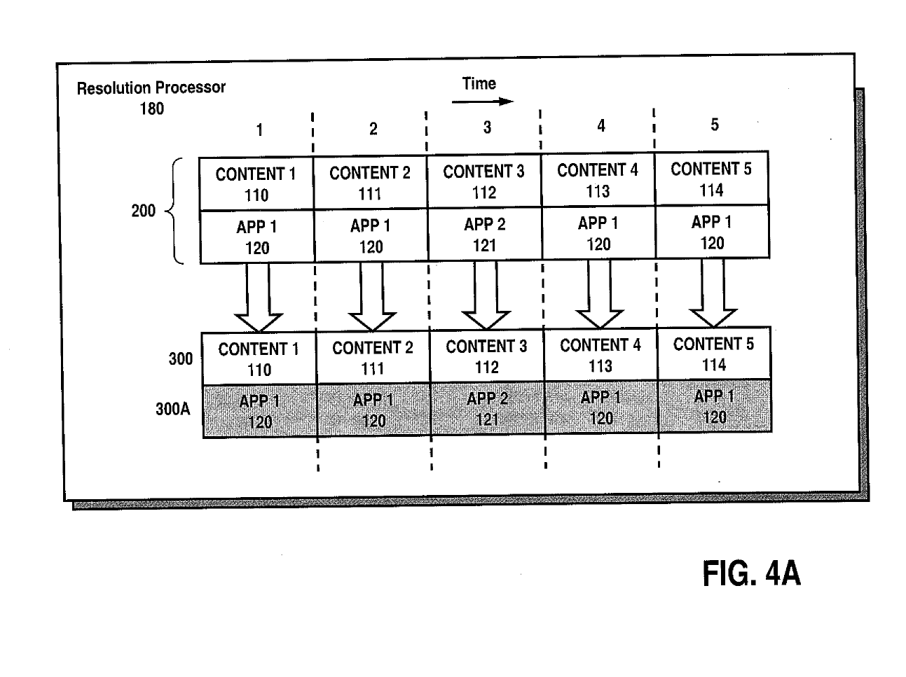

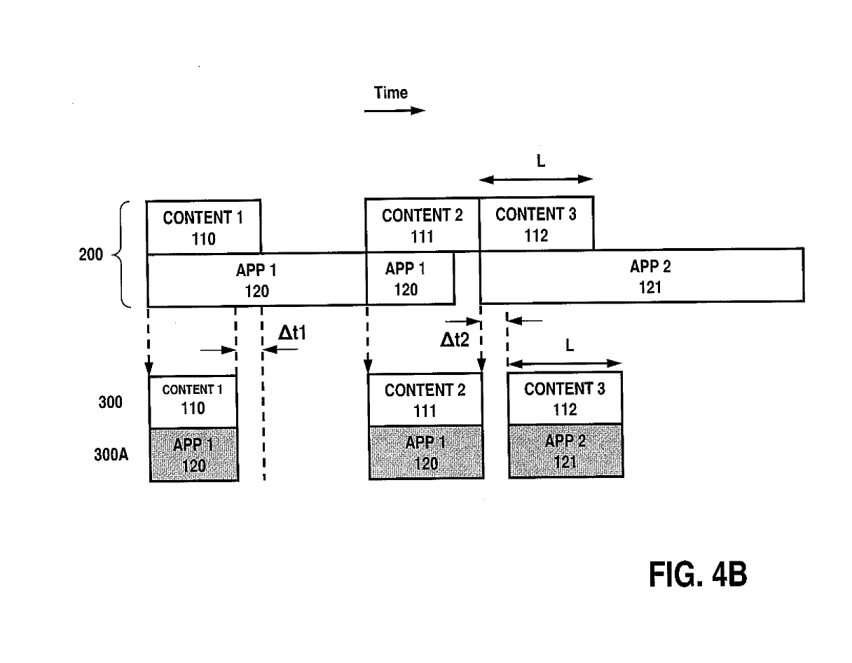

Turning to FIG. 4A, the content sequences from count server 155 and audio matching server 165 are forwarded to resolution processor 180 for further processing. In the exemplary embodiment, the content sequence 200 (discussed above in connection with FIG. 2) is compared to content sequence 300 (discussed above in connection with FIG. 3). Both content sequences pertain to a specific user that is registered to a specific device (e.g. computer) and a specific portable device (e.g. PPM™ ). During processing, the resolution processor compares the content in each time period (periods 1-5 in FIG. 4A) to validate that the content sequences were registered correctly. In other words, if a user equipped with a portable user device accessed network content using a computer while the portable user device was in close proximity (i.e. within hearing distance), the content sequence would register in the count server 155 and the audio matching server 165 concurrently. If the content sequence was registered correctly in both servers, resolution processor 180 would validate the accuracy of the sequence. Once validated, the resolution processor would subsequently populate audio matching content sequence 300 with application data 300A obtained from the count server sequence 200.

It is appreciated that content sequences from count server 155 and audio matching server 165 will not always have a direct one-to-one alignment for verification. Accordingly, it is preferred that the resolution software in resolution processor 180 is able to process various data points from the clickstream/audio match data and correlate the data points to a timestamp. As an example, FIG. 4B illustrates a situation where the clickstream data 200 has first media content 110 opened via application 120. When the first content 110 has concluded, application 120 continues to be used for other purposes. Next, second content 111 is opened using application 120. However, application 120 is closed prior to the conclusion of content 120. Finally, third content 112 is opened using application 121, where the application is again used well after the conclusion of third content 112. During processing, resolution processor 180 would analyze the time in which content was opened, the application used, and the length of time in which content was played.

The audio match data content sequence 300 in FIG. 4B indicates that a portable user device was exposed to first (110), second (111) and third (112) content. The time of content exposure in the portable device is indicated by a timestamp appended to the research data provided to the audio matching server 165. In this case, the time of exposure to the first content 110 in audio matching content sequence 300 is shorter (Δt1) than the first content 110 in sequence 200. This could occur, for example, if the portable user device was moved to an area outside the audio range of a computer for a period of time. As such, even though the content lengths are not identical, resolution processor 180 would recognize that the time in which the content was first registered in count server 155 and audio matching server 165 is sufficiently close and the content exposure is of a sufficient length to verify that the user was exposed to content 110. Accordingly, audio matching content sequence 300 would be appended with application data 300A to indicate that content 110 was accessed using application 120.

Continuing with FIG. 4B, content 111 in content sequence 200 is registered using the clickstream data, even though application 120 was closed prior to the conclusion of the content. As content 111 in audio matching content sequence 300 is registered at substantially the same time, application data 300a is similarly appended to indicate that content 111 was accessed using application 120. Content 112 in content sequence 200 is registered along with application data 121, indicating that application 121 was further used after the conclusion of content 112. Here, content 112 of audio matching sequence 300 is registered at a slightly later time period (Δt2) than that of sequence 200. If the time period is sufficiently small to be within a predetermined margin of error, resolution processor 180 will register the content as a match. Additionally, the time period (L) in which the content was played may also be taken into account to improve accuracy. Once a match is determined, application data 300A is appended to content 112, indicating that application 121 was used to access the content.

The above example illustrates the additional flexibility provided to content providers and advertisers in measuring content exposure. In an alternate embodiment, the resolution software may be programmed to provide “weights” to content sequence measurements to improve accuracy. For example, if nine out of ten sequences match between a content sequence and audio matching sequence, the non-matching sequence may be given a weighted value to determine a probability that the non-matching sequence was an anomaly, and should be included. Similarly, non-matching sequences at the end of a sequence may be weighted to exclude the data, as it is more likely that the user became disengaged with the content at that time. Also, as mentioned above, the length of time in which content was played could be used to further supplement the weight factors. Content having a shorter audio matching exposure time should be given preference, as the shortened exposure would indicate that the user was not near the computer throughout the duration of the content.

The differences in time when content is first registered in the count server 155 and audio matching server 165 may be adjusted (e.g., 0.05 sec-2 sec) to take into account hardware and network latencies (as well as audio signal propagation) that may exist. This way, content may still be accurately registered in resolution processor 180, even though the timestamps are not identical. Moreover, the time difference adjustments may be dynamically linked to the sequence “weights” described above to capture more data accurately; as the number of sequence matches increase, the time difference may be increased in proportion.

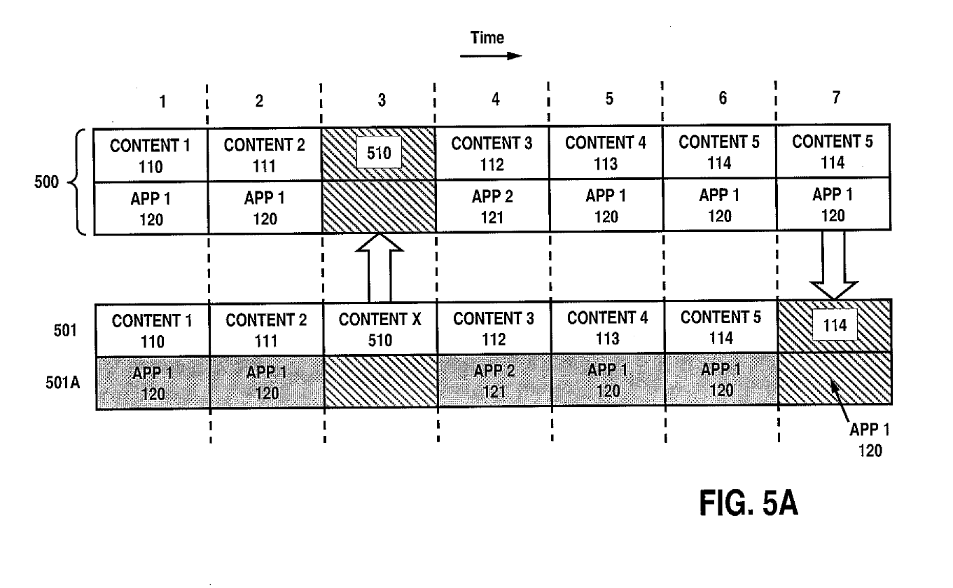

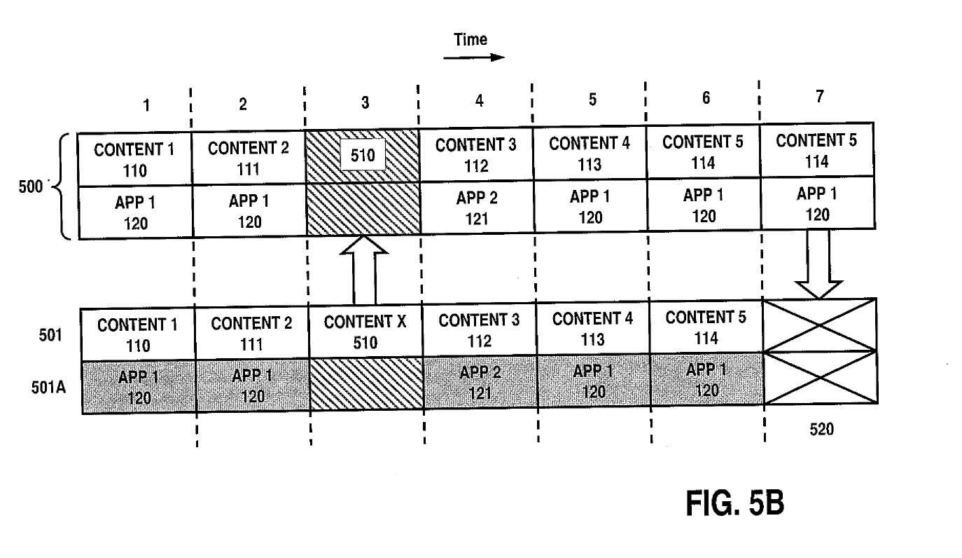

Information from the content sequences and audio match sequences may be used to supplement one another's data. In FIG. 5A, content sequence 500 and audio matching content sequence 501 are compared. In this example, time periods 1-2, and 4-7 are determined as matches, and the audio match content sequence 501 is appended with application data 501A for each respective time period. In time period 3 however, the audio matching content sequence has registered “content X” 510 that was not detected in content sequence 500. This could happen for example, if a portable user device is carried into another room where a television or radio station is playing content, and the portable user device registers that content in the portable device. In this case, the resolution software may be configured to allow data from audio matching content sequence 501 to populate missing time periods in content sequence 500. As such, content sequence 501 would be populated with content 510 for the given time period as shown in FIG. 5A. For time period 7, content 114 is registered in content sequence 500, but is missing (or corrupted) for audio matching content sequence 501. Provided the resolution software is appropriately configured, the missing content 114 is populated into sequence 501, as well as the application data 120.

In an alternate embodiment, FIG. 5B illustrates the same configuration as FIG. 5A, except that the resolution software is configured to exclude missing content under certain conditions. Here, data at the end of content sequence 500 (time period 7) is missing for audio matching content sequence 501. As this would suggest that a user was not present in front of the computing device, the data is prevented (520) from being transferred. In a further processing step, content 114 in time period 7 could be removed from the sequence, as it does not represent a “true” exposure.

It can be seen from the embodiments discussed above that the system provides a powerful new tool for content providers and advertisers to accurately measure and interpret content exposure. Although various embodiments of the present invention have been described with reference to a particular arrangement of parts, features and the like, these are not intended to exhaust all possible arrangements or features, and indeed many other embodiments, modifications and variations will be ascertainable to those of skill in the art.

As an example, location-based data could also be incorporated to improve the functionality of the system. If a portable user device and laptop are connected to the same Wi-Fi hotspot, this would indicate a high statistical probability that the user is near the content during playback. Wi-Fi signal strengths could further be compared to determine relative distances of portable user devices to the computer. GPS data could also be used to determine locations of users.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for measuring content exposure in a computer system, comprising:
receiving a first sequence of a plurality of first content data, each of the first content data including content information relating to media;
receiving a second sequence of a plurality of second content data, each of the second content data being derived at least in part from transduced media audio;
processing the first and second sequences to determine if a match exists between each of the plurality of first and second content data.

2. The method according to claim 1, wherein the first content data comprises application information indicating at least one of (i) an originating source of the media and (ii) a software application used to access the media.

3. The method according to claim 2, wherein the first content data further comprises network information associated with accessing the media.

4. The method according to claim 1, wherein the second content data comprises at least one of (i) ancillary codes decoded from the media audio, and (ii) signature data extracted from the media audio.

5. The method according to claim 2, wherein the first sequence of the plurality of first content data is associated with a first device, and the second sequence of the plurality of second content data is associated with a second device.

6. The method of claim 5, further comprising the step of receiving identification information for a user associated with the first and second device.

7. The method of claim 6, wherein the step of processing the first and second sequences comprises comparing the times in which each of the first content data and second content data was received in each respective device to determine if a match exists.

8. The method of claim 7, wherein the step of processing the first and second sequences comprises the step of populating the second content data with application data if a match is determined to exist.

9. The method of claim 7, wherein the step of processing the first and second sequences comprises comparing the length of exposure time for each of the first content data and second content data in each respective device to determine if a match exists.

10. The method of claim 7, wherein each of the times in which first content data and second content data was received is compared to a predetermined time period.

11. A system for measuring content exposure in a computer system, comprising:
a processing device configured to receive communication over a network and for receiving a first sequence of a plurality of first content data, each of the first content data including content information relating to media, the processing device further receiving a second sequence of a plurality of second content data, each of the second content data being derived at least in part from transduced media audio; and
wherein the processing device processes the first and second sequences to determine if a match exists between each of the plurality of first and second content data.

12. The system according to claim 11, wherein the first content data comprises application information indicating at least one of (i) an originating source of the media and (ii) a software application used to access the media.

13. The system according to claim 12, wherein the first content data further comprises network information associated with accessing the media.

14. The system according to claim 11, wherein the second content data comprises at least one of (i) ancillary codes decoded from the media audio, and (ii) signature data extracted from the media audio.

15. The system according to claim 12, wherein the first sequence of the plurality of first content data is associated with a first device, and the second sequence of the plurality of second content data is associated with a second device.

16. The system of claim 15, wherein the processing device receives identification information for a user associated with the first and second device.

17. The system of claim 15, wherein the processing device processes the first and second sequences by comparing the times in which each of the first content data and second content data was received in each respective device to determine if a match exists.

18. The system of claim 17, wherein the processing device populates the second content data with respective application data if a match is determined to exist.

19. The system of claim 17, wherein the processing device compares the length of exposure time for each of the first content data and second content data in each respective device to determine if a match exists.

20. The system of claim 17, wherein each of the times in which first content data and second content data was received is compared to a predetermined time period.
